(19) United States
(12) Patent Application Publication
(10) Pub. No.: US 2025/0133324 A1
(43) Pub. Date: Apr. 24, 2025

(54) HEADPHONE DEVICE

(71) Applicant: Tymphany HK Limited, Hong Kong (HK)

(72) Inventors: Tung-Wen TU, Taipei City (TW); Chia-Shuo CHANG, Taipei City (TW); Chi-Tai HO, Taipei City (TW); Ke-Hua LIN, Taipei City (TW)

(21) Appl. No.: 18/799,785

(22) Filed: Aug. 9, 2024

Related U.S. Application Data
(60) Provisional application No. 63/591,562, filed on Oct. 19, 2023.

(51) Int. Cl. H04R 1/10

(52) U.S. Cl. CPC H04R 1/1075; H04R 1/1008

(57) ABSTRACT

A headphone device of the invention includes a headband, a pair of joining members, a pair of holding members and a pair of sound generating modules. The headband is arc-shaped and has a first end and a second opposite to the first end. The joining members are movably disposed on the headband to approach or apart from the first end and the second end, and each of the joining members includes an upper contact portion extending towards another of the joining member. The holding members are rotatably joined to the joining members respectively, wherein each of the holding members includes a first pivot portion rotatably connected to one of the joining members and a holding portion secured to first pivot portion. The sound generating modules detachably disposed in the holding portion. The holding members rotate between a stretch position and a fold position.

### CROSS-REFERENCE TO RELATED APPLICATIONS

This application claims priority of U.S. Provisional Application No. 63/591,562, filed on Oct. 19, 2023 under 35 U.S.C. § 119 (e), the entire contents of which are hereby incorporated by reference.

### BACKGROUND OF THE INVENTION

### Field of the Invention

The invention relates to an audio equipment, and more particularly to a foldable headphone.

### Description of the Related Art

An earphone device is an audio device worn on head or inserted into ears and configured to convert audio signals into sound waves transmitted into the user's ears. The user utilizes the earphone to hear music without disturbing other people around or separate himself/herself from the external environment. Conventional earphones include many types, such as headphone, earbuds, supra aural earphone and bone conduction earphone. The headphone is worn on head with speakers covering ears, whereby the user may experience excellent music effect through separation of almost sounds from the external environment. However, as the headphone often has a considerable size, it is not convenient for the user to carry and use.

### BRIEF SUMMARY OF THE INVENTION

An object of the present invention is to provide a headphone device solving the problem of inconvenient in carry and usage for the conventional headphone device.

The headphone device in accordance with an exemplary embodiment of the invention includes a headband, a pair of joining members, a pair of holding members and a pair of sound generating modules. The headband is arc-shaped and has a first end and a second opposite to the first end. The joining members are movably disposed on the headband to approach or apart from the first end and the second end. The holding members are rotatably joined to the joining members respectively, wherein each of the holding members includes a first pivot portion rotatably connected to one of the joining members and a holding portion secured to first pivot portion. The sound generating modules detachably disposed in the holding portion. The holding members rotate between a stretch position and a fold position.

In another exemplary embodiment, each of the holding portions is annular, each of the sound generating modules includes a housing of barrel shape, and the sound generating module is detachably mounted to the holding portion through shape fitting.

In yet another exemplary embodiment, each of the joining members includes a second pivot portion rotatably connected to the first pivot portion, the second pivot portion includes a first limiting surface and a limiting end perpendicular to the first limiting surface, and the first pivot portion includes a second limiting surface and a third limiting surface parallel to the second limiting surface, and the holding member rotates with respect to the joining member from the stretch position until the limiting end contacts the third limiting surface, where the holding member arrives the fold position.

In another exemplary embodiment, each of the holding member further includes an abut portion protruding from an outer peripheral surface of the holding portion, the abut portions of the pair of the holding members abut against each other when the holding members are at the fold position.

In yet another exemplary embodiment, each of the joining members includes a first joining portion movable to approach or apart from the first end or the second end and a second joining portion rotatably connected to the holding member, each of the sound generating modules includes at least one venting hole.

In another exemplary embodiment, the first joining portion and the second joining portion are detachably joined through engagement of an engaging rib and an engaging groove extending along a direction perpendicular to the headband.

In yet another exemplary embodiment, each of the joining portion further includes a sliding portion connected to the first joining portion, and the headband further includes a sliding groove in which the sliding portion slides.

In another exemplary embodiment, each of the joining member further includes a rack portion disposed on one side of the sliding portion, and the rack portions of the pair of joining members are opposite, and the headband further includes a gear meshing the rack portions, whereby the pair of joining members slide synchronously in opposite directions.

In yet another exemplary embodiment, each of the joining members further includes a stop portion disposed at one end of the rack portion, and the movement of the joining members is limited by contact of the stop portion and the gear.

In another exemplary embodiment, each of the sound generating modules includes a charging port and an electrical connection portion, a charging cable is inserted into the charging port, and the electrical connection portions of the pair of the sound generating modules contact, whereby the sound generating modules are parallel connected for electrical charging.

In yet another exemplary embodiment, the headband further includes a soft pad disposed on one side facing the sound generating modules and between the first end and the second end.

In another exemplary embodiment, each of the joining members includes an abutting spring sheet and a guiding plate, each of the holding members includes an abutting plate disposed between the abutting spring sheet and the guiding plate, the guiding plate has a planar portion and an arced portion, the abutting spring sheet abuts the abutting plate to enable the abutting plate to abut the planar portion when the holding members are at the stretch position, the abutting plate move along the arced portion when the holding members move toward the fold position, and the abutting spring sheet abuts an edge of the abutting plate to position the holding members at the fold position after the holding member arrives the fold position.

In yet another exemplary embodiment, each of the sound generating modules further includes a joining pin, each of the holding members further includes a joining hole, the sound generating module is detachably joined to the holding portion through insertion of the joining pin into the joining hole.

The present invention provides another an exemplary embodiment includes a headband, a pair of joining members and a pair of sound generating modules. The headband is arc-shaped and having a first end and a second opposite to the first end. The joining members are disposed on the head band, wherein each of the joining members includes an upper contact portion extending towards another of the joining member. The sound generating modules are joined to the pair of joining members respectively.

In another exemplary embodiment, the headphone device further includes a pair of holding members joined to the pair of joining members respectively, wherein each of the holding members includes a holding portion in which the sound generating module is disposed and a first lower extending portion extending towards the other one of the holding members.

In yet another exemplary embodiment, each of the holding members further includes a first lower contact portion enclosing an outer surface of the first lower extending portion having a shape of bending rod.

In another exemplary embodiment, each of the holding members further includes a second lower extension portion disposed at the holding portion and opposite to the first lower extension portion, and the second lower extension portion extends towards the other one of the holding members.

In yet another exemplary embodiment, the second extension portion includes a radial wall radially extending from the holding portion and an axial wall perpendicular to the radial wall, and the axial wall is opposite to the first lower extension portion.

In another exemplary embodiment, each of the holding members further includes a second lower contact portion disposed at an edge of the axial wall.

In yet another exemplary embodiment, the headphone device further includes a pair of holding members, wherein each of the holding members includes a holding portion in which the sound generating module is disposed, an abutting portion protruding away from the holding member and a first lower contact portion disposed at an end of abutting portion away from the holding portion, the abutting portions of the holding members abut against each other when the holding members rotate towards the head band.

In another exemplary embodiment, the headphone device further includes a pair of holding members, wherein each of the holding members includes a holding portion in which the sound generating module is disposed, a lower extension portion extending from the holding portion towards the other one of the holding members and a second contact portion disposed at an edge of the lower extension portion, and the lower extension portion has an arced shape.

In yet another exemplary embodiment, the headband, the joining members and the sound generating module are integrally formed.

As the joining members are movably disposed on the headband, the user may adjust positions of the joining members according to a distance between the head and the ears of the user. As the holding members are rotatably connected to the joining members, the holding members along with the sound generating modules mounted therein are folded towards the headband, whereby the size of the headphone is reduced and thus convenient for carry. The sound generating modules can be charged when the sound generating modules are mounted in the holding members or detached therefrom. The detached sound generating modules are electrically charged individually, or the sound generating modules are electrically connected each other, and one of the sound generating modules is connected to a power supply for electrically charging.

As the upper contact portions are disposed on the joining members, when a user wears the headphone of the present invention on his/her head, the upper contact portions abut a face of the user, whereby the sound generating modules are separated from the face of the user by a distance.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of a first embodiment of a headphone of the present invention;

FIG. 2 is a front view of the headphone of FIG. 1;

FIG. 3 is a partially exploded front view of the headphone of FIG. 2, wherein the sound generating modules are detached from the holding members;

FIG. 4 is a partially exploded perspective view of the headphone of FIG. 1, wherein the sound generating modules are detached from the holding members;

FIG. 5 is a front view of the headphone of FIG. 1, wherein the holding members are rotated from a stretch position to a fold position;

FIG. 6 is perspective view of the headphone of FIG. 1, wherein the holding members are rotated from a stretch position to a fold position;

FIG. 7 is a perspective view of the headphone of FIG. 1, wherein the first joining portion and the second joining portion of the joining members are separated;

FIG. 8 is a side view of FIG. 7;

FIG. 9 is an exploded view of the headband of the headphone of FIG. 1;

FIG. 10 is a bottom view of the headphone of FIG. 1;

FIG. 11 is a perspective view of a second embodiment of the headphone of the present invention;

FIG. 12 is a front view of the headphone of FIG. 11, wherein the sound generating modules are rotated to fold;

FIG. 13 is a perspective view of a third embodiment of the headphone of the present invention;

FIG. 14 is a partially exploded view of the headphone of FIG. 13;

FIG. 15 is a front view of FIG. 13;

FIGS. 16, 17 and 18 illustrates three electrical charging methods of the sound generating modules;

FIG. 19 is a perspective view of a fourth embodiment of the headphone of the present invention;

FIG. 20 is a partially exploded view of the headphone of FIG. 19;

FIG. 21 is a front view of the headphone of FIG. 19, wherein the sound generating modules are rotated to fold;

FIG. 22 is a perspective view of a rotation mechanism of the sound generating modules of the headphone of FIG. 19;

FIG. 23 is an enlarged view of portion A of FIG. 22; and

FIG. 24 is a front view of the rotation mechanism of FIG. 22, wherein the holding members are rotated from a stretch position to a fold position.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

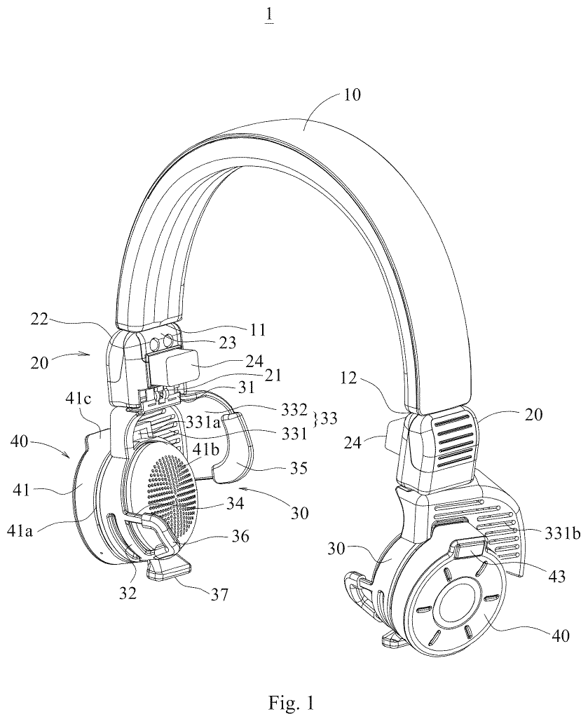

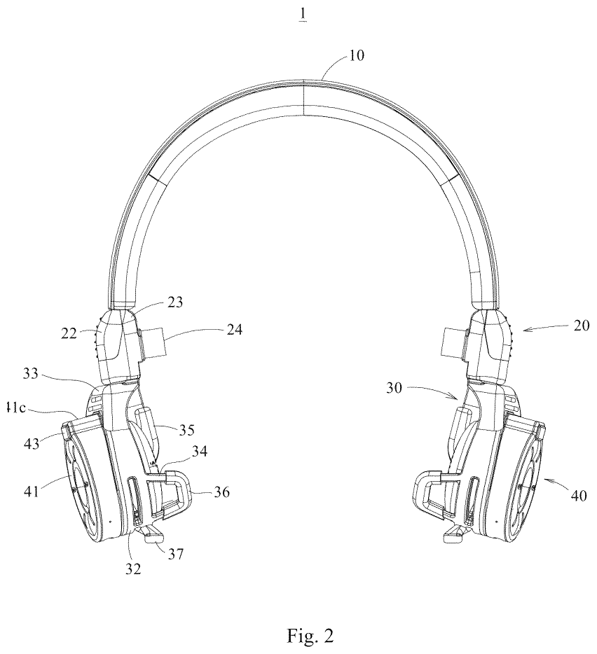

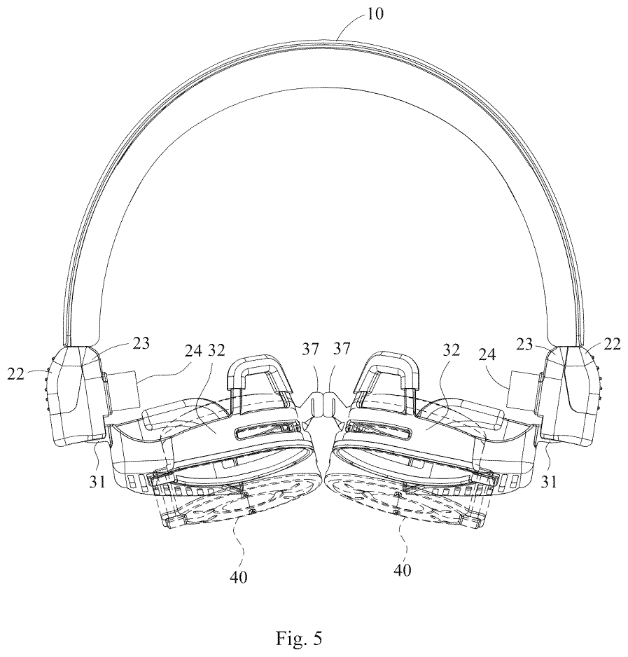

Referring to FIGS. 1 and 2, a first embodiment of a headphone of the present invention is disclosed. The headphone 1 of the present embodiment includes a headband 10, a pair of joining members 20, a pair of holding members 30 and a pair of sound generating modules 40. The headband 10 is arc-shaped for fitting a head of a user. The headband 10 has a first end 11 and a second end 12. The joining members 20 are movably disposed on two ends of the headband 10 respectively. One of the joining members 20 slides on the headband 10 close to or apart from the first end 11, and the other one of the joining members 20 slides on the headband 10 close to or apart from the second end 12. The holding members 30 are rotatably connected to the joining members 20. Each of the holding members 30 includes a first pivot portion 31 and a holding portion 32. The first pivot portion 31 is rotatably connected to the joining member 20, and the holding portion 32 is secured to the first pivot portion 31. The sound generating modules 40 are detachably disposed in the holding portions 32 respectively. The holding members 30 are roratable between a stretch position and a fold position. When the holding members 30 are at the stretch position, as shown in FIG. 1, the holding members 30 are aligned with the headband 10 respectively. As shown in FIG. 5, the holding members 30 rotate from the stretch position to approach each other and get closed to the headband and finally reach the fold position.

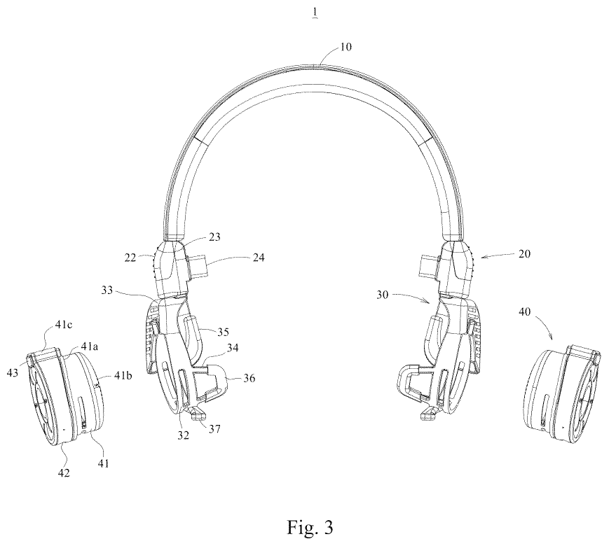

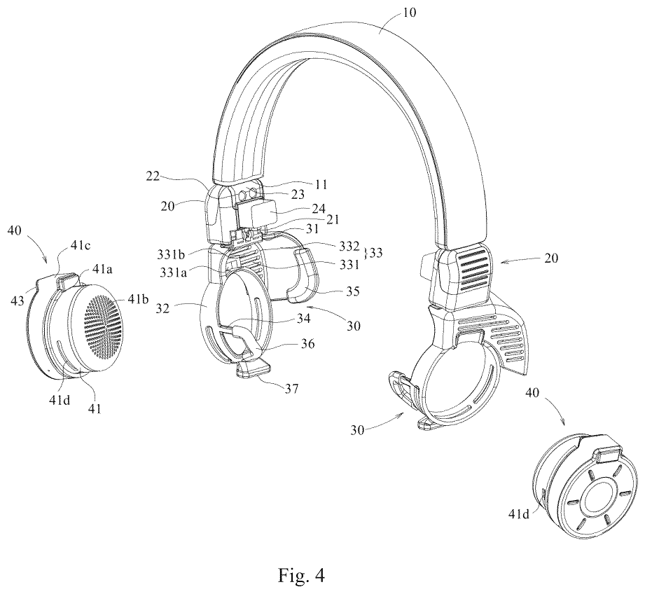

Referring to FIGS. 3 and 4, each of the holding members 30 further includes a second lower extension portion 33, a first lower extension portion 34, a second lower contact portion 35 and a first lower contact portion 36. The holding portion 32 is annular. The sound generating modules 40 includes a housing 41 having a barrel shape and step structure 41a. When the housing 41 is mounted to the holding portion 32, the housing 41 is assembled to the holding portion 32 through shape fitting, and the step structure 41a abuts on an edge of the holding portion 32 for axial positioning. The housing 41 has a plurality of sound holes 41b facing ears of a user. Sound waves from the sound generating modules 40 are transmitted into the ears of the user through the sound holes 41b.

Although the housing 41 is assembled to the holding portion 32 through shape fitting in the present embodiment, the present invention is not limited thereto. In other embodiments, the housing 41 is detachably mounted to the holding portion 32 through magnetic members.

Moreover, although the housing 41 is inserted into the holding portion 32 from an outer side towards an inner side of the headphone 1, the present invention is not limited thereto. In other embodiments, the step structure 41a is disposed on the opposite side, whereby the housing 41 is inserted into the holding portion 32 from an inner side towards an outer side of the headphone 1.

The second lower extension portion 33 is disposed at an outer peripheral surface and connected to the holding portion 32 and the first pivot portion 31. The second lower extension portion 33 includes a radial wall 331 and an axial wall 332. The radial wall 331 is connected to an outer peripheral wall of the holding portion 32, and the axial wall 332 is perpendicular to the radial wall 331 and extends towards the other holding member 30. The first lower extension portion 34 is disposed at an edge of the holding portion 32 and extends radially toward the other holding member 30. The axial walls 332 of the second lower extension portion 33 and the first lower extension portion 34 are opposite. The radial wall 331 includes an engaging groove 331a and a plurality of slots 331b. The engaging groove 331a is adjacent to an outer peripheral surface of the holding portion 32. The housing 41 further includes an engaging protrusion 41c engaging the engaging groove 331a, whereby the housing 41 is constrained in the peripheral direction to avoid rotation in the holding portion 32.

The second lower contact portion 35 is disposed at an edge of the axial wall 332, and has a flange structure made of soft material, such as rubber. The first lower extension portion 34 has a bending rod structure of U shape. The first lower contact portion 36 encloses an outer peripheral surface of the first lower extension portion 34. The first lower contact portion 36 is made of soft material, such as rubber. The first lower contact portion 36 and the second lower contact portion 35 are configured to abut against the face in front of the ears and the neck behind the ears of the user, whereby the sound generating modules 40 are separated from the ears by a distance, thereby enhancing the experience of music from the sound generating modules 40 and avoiding uncomfortable feeling caused by contact of the sound generating modules 40 on the ears for a longer period.

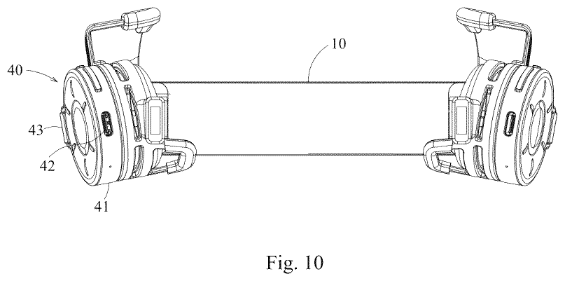

Referring to FIGS. 4 and 10, the housing 41 of the sound generating modules 40 includes a plurality of venting holes 41d. The venting holes 41d are slot-like shaped and located on the outer peripheral surface of the housing 41 in an equally-distanced manner. The interior of the housing 41 communicates with the external environment through the venting holes 41, whereby heat generated by electronic components of the sound generating modules 40 is dissipated.

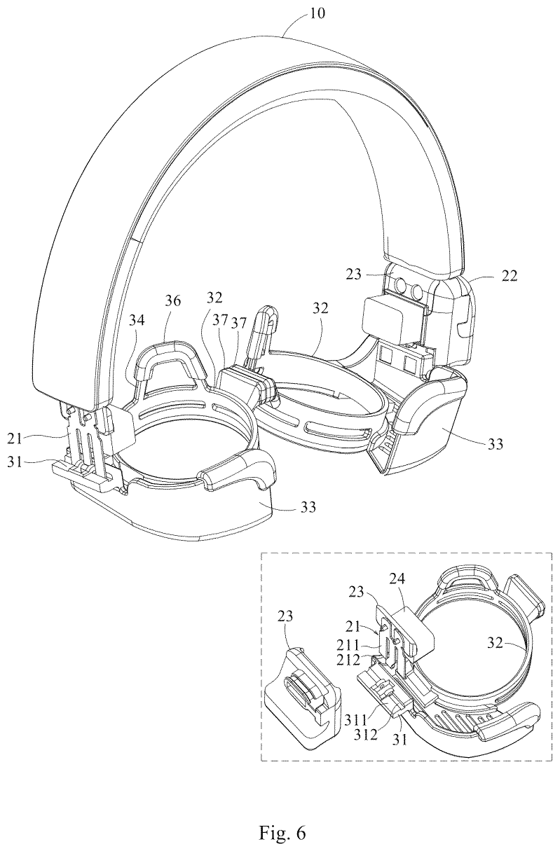

Referring to FIGS. 5 and 6, each of the joining members 20 includes a second pivot portion 21. The second pivot portion 21 is rotatably connected to the first pivot portion 31 of the holding member 30. The second pivot portion 21 has a first limiting surface 211 and a limiting end 212 perpendicular to the first limiting surface 211. The first pivot portion 31 includes a second limiting surface 311 and a third limiting surface 312 horizontally adjacent to the second limiting surface 311. When the holding members 30 are at the stretch position, the first limiting surface 211 abuts against the second limiting surface 311 to prevent the holding member 30 from rotating outwards. When the holding member 30 rotates from the stretch position toward the fold position, the holding member 30 rotates with respect to the joining member 20 until the limiting end 212 abuts against the third limiting surface 312, where the holding member 30 reaches the fold position and stops. Therefore, the holding member 30 rotates an angle of 90° with respect to the joining member 20, that is the stretch position and the fold position are separated by an angular distance of 90°.

Each of the holding members 30 further includes an abutting portion 37 protruding from the outer peripheral surface of the holding portion 32 and away from the first pivot portion 31. When the holding members 30 are at the fold position, the abutting portions 37 of the pair of holding members 30 abut against each other. In other embodiments, the holding member 30 has no abutting portion, and the pair of the holding members 30 fail to abut against each other when the holding members 30 are at the fold position.

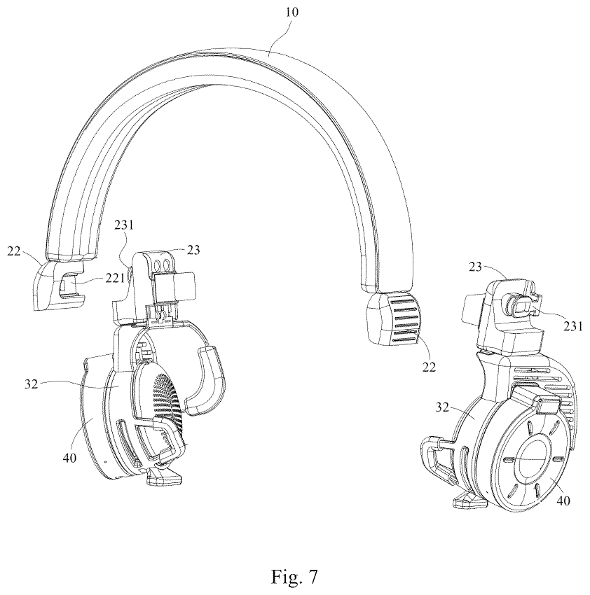

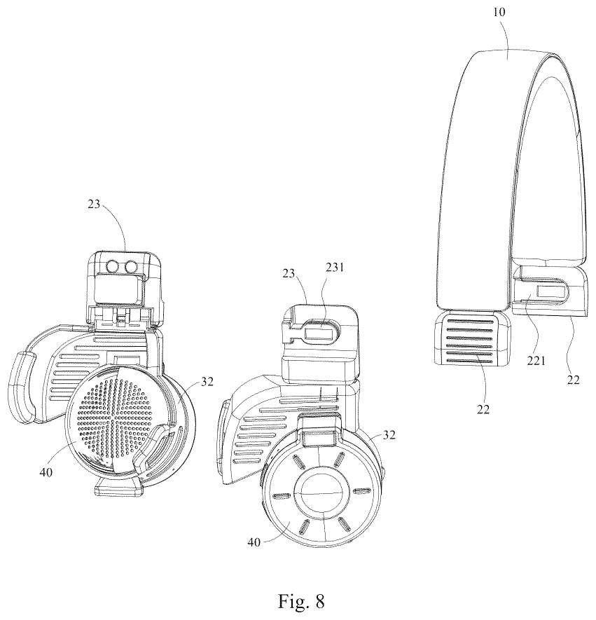

Referring to FIGS. 7 and 8, each of the joining members 20 further includes a first joining portion 22 and a second joining portion 23 detachably assembled to the first joining portion 22. The first joining portion 22 slides on the headband 10 to approach or apart from the first end 11 or the second end 12, and the second joining portion 23 is rotatably connected to the holding member 30. The first joining portion 22 is located on an outer side of the joining member 20, and the second joining portion 23 is located on an inner side of the joining member 20. The second pivot portion 21 is disposed between the first joining portion 22 and the second joining portion 23 and connected to the second joining portion 23. The first joining portion 22 has an engaging groove 221, and the second joining portion 23 has an engaging rib 231. The first joining portion 22 is detachably assembled to the second joining portion 23 through engagement of the engaging groove 221 and the engaging rib 231. The engaging groove 221 extends along a direction perpendicular to the headband 10, whereby the second joining portion 23 along with the holding members 30 and the sound generating module 40 is moved laterally and detached from the first joining portion 22.

Each of the joining members 20 further includes an upper contact portion 24, which is a protrusion disposed on a surface of the second joining portion 23. The upper contact portion 24 is made of soft material, such as rubber. The upper contact portion 24 abuts against a position on the face and above the ears. The upper contact portion 24, the first lower contact portion 36 and the second lower contact portion 35 contact at three positions on the face of the user, whereby the sound generating modules 40 is separated from the ears of the user by a determined distance.

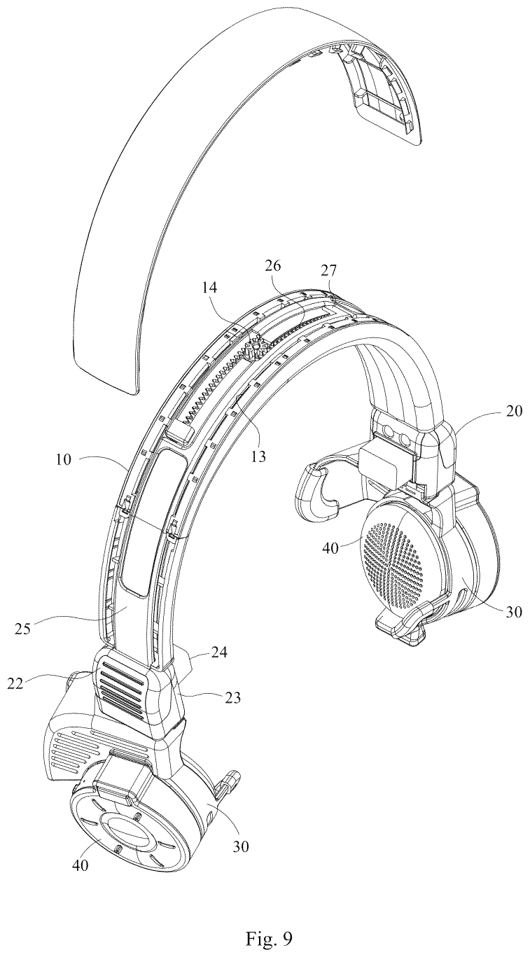

Referring to FIG. 9, each of the joining members 20 further includes a sliding portion 25, a rack portion 26 and two stop portions 27a, 27b. The sliding portion 25 is connected to the first joining portion 22. The headband 10 includes a sliding groove 13 opened at the first end 11 and the second end 12. The sliding portion 25 is slidably mounted in the sliding groove 13, whereby the first joining portion 22 is capable of moving along the headband 10. The rack portion 26 includes a plurality of teeth and disposed at one side of the sliding portion 25. The rack portions 26 of the pair of the joining members 20 are opposite. The headband 10 further includes a gear 14 disposed at a center of the sliding groove 13. The rack portions 26 of the joining member 20 mesh the gear 14 at opposite sides, whereby the joining members 20 moves synchronously in opposite directions. One of the stop portions 27 is disposed at one end of the rack portion 26. The movement of the sound generating modules 40 is limited through contact of the stop portion 27 and the gear 14. Therefore, the position of the sound generating modules 40 is adjusted according to the user.

Although a surface of the first joining portion 22 has a plurality of rib structures configured to increase friction between a hand of the user and the first joining portion 22, the invention is not limited thereto. In other embodiments, the first joining portion 22 has a smooth surface without any rib structure.

Referring to FIGS. 1, 4 and 10, the sound generating module 40 further includes a charging port 42 and an electrical connection portion 43. The charging port 42 is configured for insertion of a charging cable. The electrical connection portions 43 of the pair of the sound generating modules 40 are contact, whereby circuits of the sound generating modules 40 are serial or parallel connected. Therefore, the pair of sound generating modules 40 are electrically charged together when the charging port 42 of one sound generating module 40 is connected to a power supply. In other embodiments, the sound generating modules 40 are detached from the holding member 30 and inserted into a charging box for electrical charging. The charging port 42 of the present embodiment is a port of USB type C.

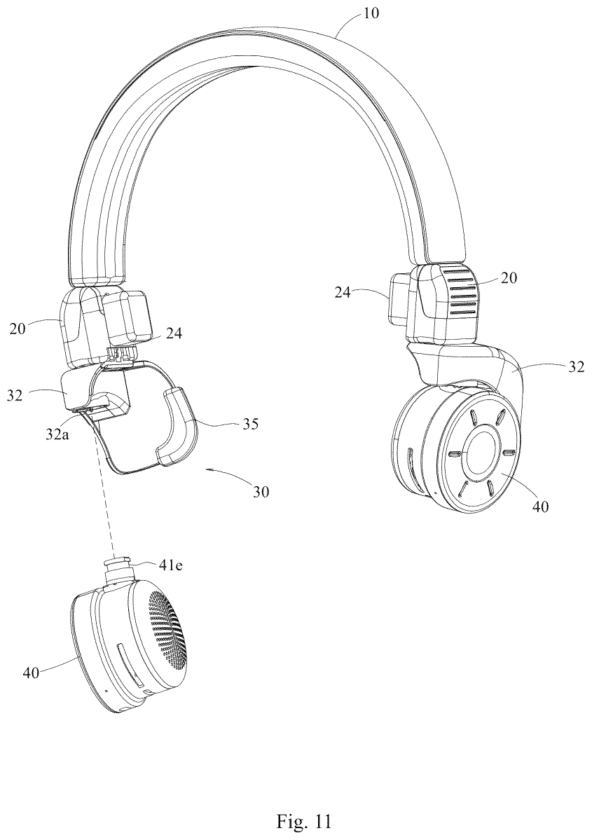

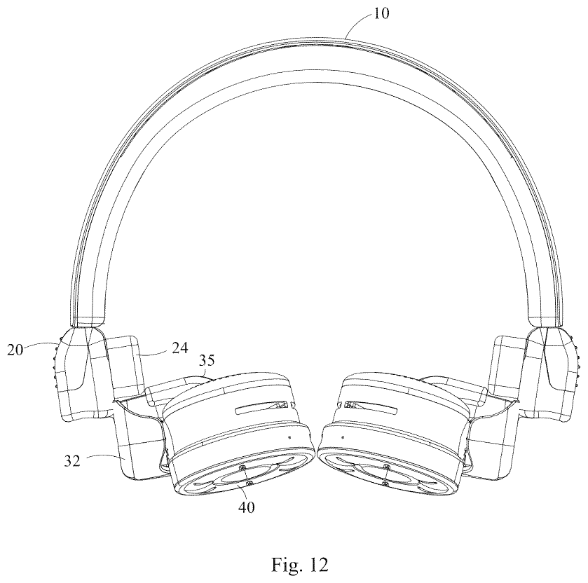

Referring to FIGS. 11 and 12, a second embodiment of the headphone of the present invention is disclosed. As a portion of components of the present embodiment is the same as the first embodiment, the identical components of the two embodiments are given the same numerical and the description thereof is thus omitted. The holding member 30 of the present embodiment has no first lower contact portion and the abutting portion. Moreover, the sound generating module 40 of the present embodiment further includes a joining pin 41e, and the holding portion 32 of the holding member 30 further includes a joining hole 32a. The sound generating module 40 is detachably joined to the holding portion 32 through insertion of the joining pin 41e into the joining hole 32a.

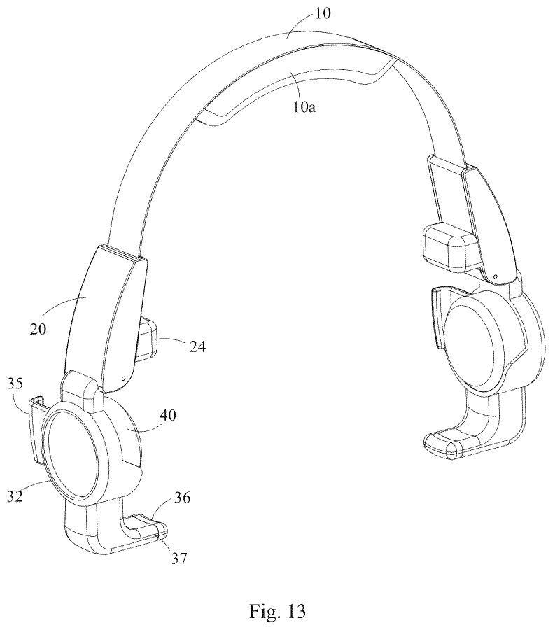

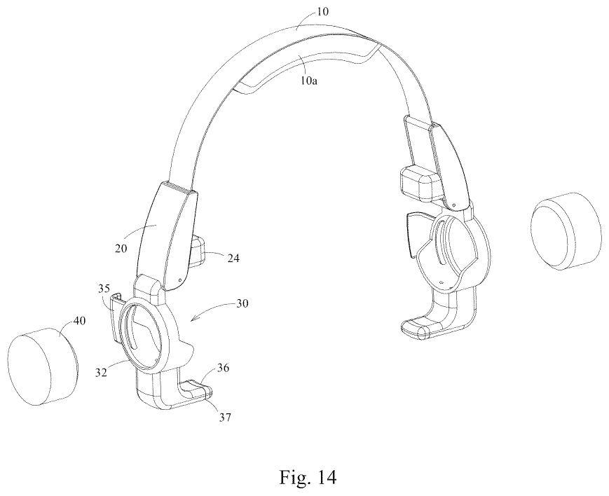

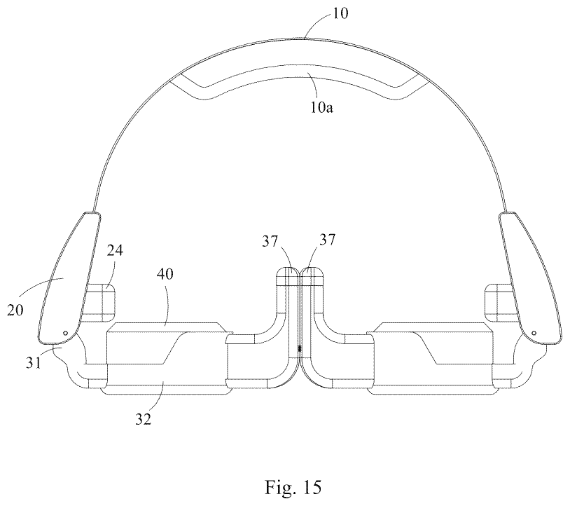

Referring to FIGS. 13, 14 and 15, a third embodiment of the headphone of the present invention is disclosed. As a portion of components of the present embodiment is the same as the first embodiment, the identical components of the two embodiments are given the same numerical and the description thereof is thus omitted. The headband 10 of the present embodiment is a metal plate. The joining member 20 includes a guiding groove, two ends of the headband 10 are inserted into the guiding grooves of the joining members 20 respectively, whereby the joining members 20 slide along the headband 10. The headband 10 further includes a soft pad 10a at a position corresponding to the head of the user. The joining member 20 is pivoted to the holding member 30 through a shaft, and a torsion spring is disposed at the pivot position. The first lower contact portion 36 is disposed at one end of the abutting portion 37 away from the holding portion 32, and the second lower contact portion 35 is disposed at one side of the holding portion 32.

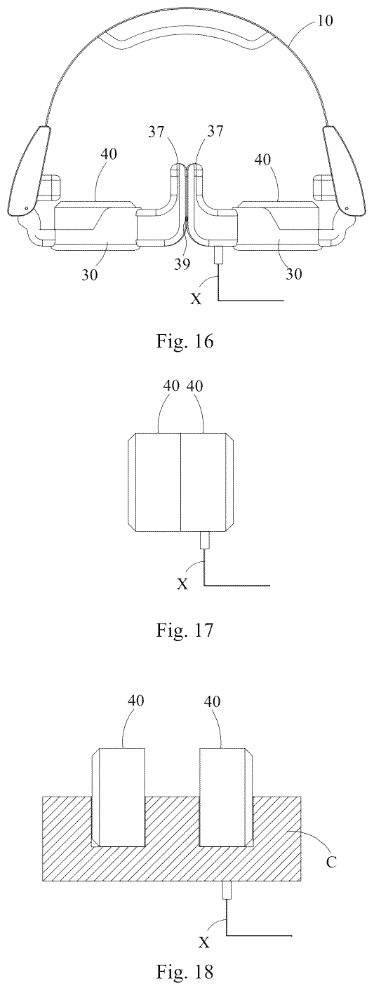

Referring to FIGS. 16, 17 and 18, three charging methods of the sound generating module 40 are illustrated. As shown in FIG. 16, the sound generating module 40 is connected to an external power supply through a cable X when the sound generating module 40 is mounted in the holding member 30, wherein the sound generating modules 40 are electrically connected through contact of electrical connection portions 39 disposed at the abutting portions 37. As shown in FIG. 17, after the sound generating modules 40 are detached from the holding members 30, and the sound generating modules 40 are electrically connected through the electrical connection portion 43. One of the sound generating modules 40 is connected to the external power supply through the cable X. As shown in FIG. 18, the sound generating modules 40 are detached from the holding members 30 and inserted into a charging box C connected to the external power supply through the cable X.

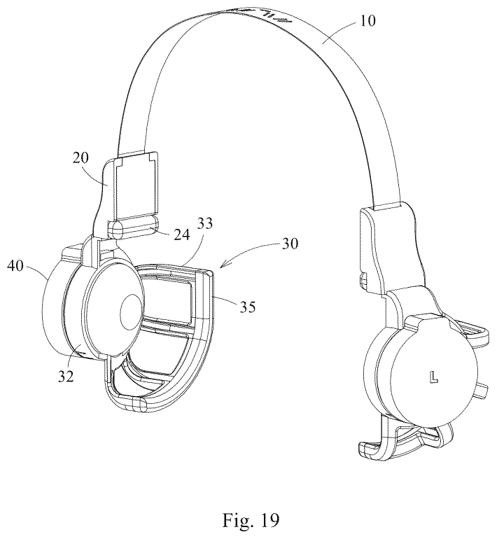

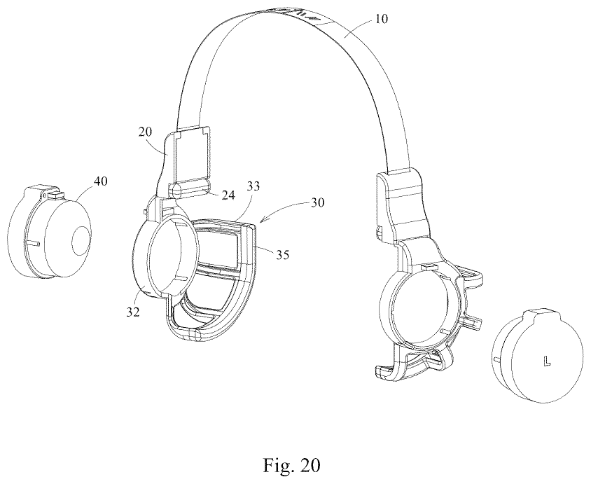

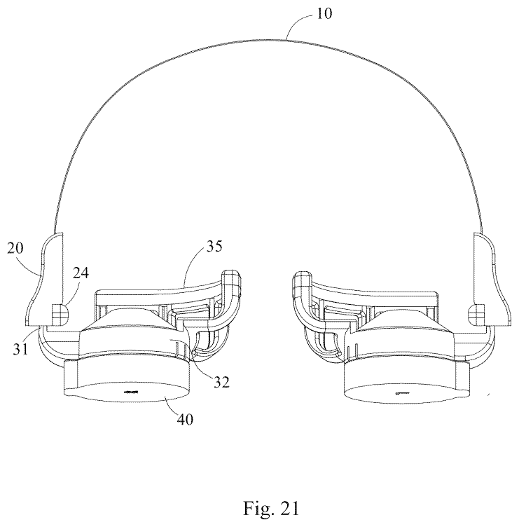

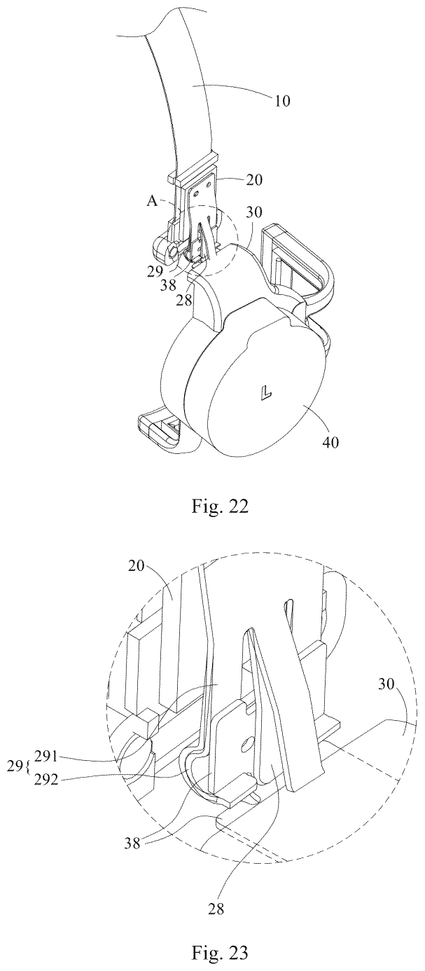

Referring to FIGS. 19, 20, 21, 22, 23 and 24, a fourth embodiment of the headphone of the present invention is disclosed. As a portion of components of the present embodiment is the same as the first embodiment, the identical components of the two embodiments are given the same numerical and the description thereof is thus omitted. The headband 10 of the present embodiment is a metal plate. The joining member 20 includes a guiding groove, two ends of the headband 10 are inserted into the guiding grooves of the joining members 20 respectively, whereby the joining members 20 slide along the headband 10. As the headband 10 is a metal plate, the headband 10 elastically deforms, and the upper contact portions 24 abut against the head of the user when the user's head wears the headband 10.

The holding members 30 includes a lower extension portion 33 connected to one side of the holding portion 32. The lower extension portion 33 is arced and extends from the holding portion 32 toward the other holding member 30. The second lower contact portion 35 configured to abut against the face of the user is disposed at an edge of the lower extension portion 33.

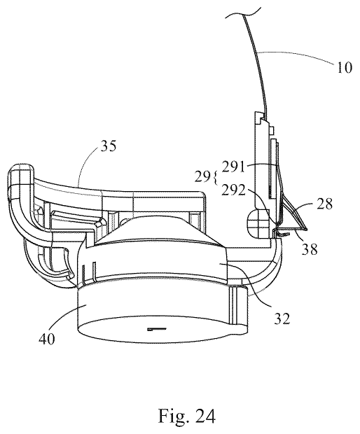

Each of the joining members 20 includes an abutting spring sheet 28 and a guiding plate 29, each of the holding members 30 includes an abutting plate 38 disposed between the abutting spring sheet 28 and the guiding plate 29, the guiding plate 29 has a planar portion 291 and an arced portion 292. The abutting spring sheet 28 abuts on the abutting plate 38 to enable the abutting plate 38 to abut against the planar portion 291 when the holding members 30 are at the stretch position, as shown in FIG. 23. The abutting plate 38 moves along the arced portion 292 when the holding members 30 move toward the fold position, and the abutting spring sheet 28 abuts on an edge of the abutting plate 29 to position the holding members 30 at the fold position after the holding member 30 arrives the fold position, as shown in FIG. 24.

Although the headband 10, the pair of joining members 20, the pair of holding members 30 and the pair of sound generating modules 40 are separated components or modules, the present invention is not limited thereto. In other embodiments, the headband 10, the pair of joining members 20, the pair of holding members 30 and the pair of sound generating modules 40 are integrally formed.

Although the headphone 1 of the present invention includes the upper contact portion 24, the first lower contact portion 36 and the second lower contact portion 35, the present invention is not limited thereto. In other embodiments, the headphone includes the upper contact portion only and has no lower contact portion.

As the joining members are movably disposed on the headband, the user may adjust positions of the joining members according to a distance between the head and the ears of the user. As the holding members are rotatably connected to the joining members, the holding members along with the sound generating modules mounted therein are folded towards the headband, whereby the size of the headphone is reduced and thus convenient for carry. The sound generating modules can be charged when the sound generating modules are mounted in the holding members or detached therefrom. The detached sound generating modules are electrically charged individually, or the sound generating modules are electrically connected each other, and one of the sound generating modules is connected to a power supply for electrically charging.

As the upper contact portions are disposed on the joining members, when a user wears the headphone of the present invention on his/her head, the upper contact portions abut on a face of the user, whereby the sound generating modules are separated from the face of the user by a distance.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A headphone device, comprising:
an arc-shaped headband having a first end and a second opposite to the first end;
a pair of joining members slidable close to or away from the first end and the second end respectively;
a pair of holding members rotatably joined to the joining members respectively, wherein each of the holding members comprises a first pivot portion rotatably connected to one of the joining members and a holding portion secured to first pivot portion; and
a pair of sound generating modules, wherein each of the sound generating modules is detachably disposed in the holding portion;
wherein the holding members rotate between a stretch position and a fold position.

2. The headphone device as claimed in claim 1, wherein each of the holding portions is annular,
wherein each of the sound generating modules comprises a housing, and
wherein each of the sound generating modules is detachably mounted to the holding portion through shape fitting.

3. The headphone device as claimed in claim 1, wherein each of the joining members comprises a second pivot portion rotatably connected to the first pivot portion, the second pivot portion comprises a first limiting surface and a limiting end perpendicular to the first limiting surface, and the first pivot portion comprises a second limiting surface and a third limiting surface parallel to the second limiting surface, and the holding member rotates with respect to the joining member from the stretch position until the limiting end contacts the third limiting surface, where the holding member arrives at the fold position.

4. The headphone device as claimed in claim 3, wherein each of the holding members comprises an abut portion protruding from an outer peripheral surface of the holding portion, and the abut portions of the pair of the holding members abut against each other when the holding members are at the fold position.

5. The headphone device as claimed in claim 1, wherein each of the joining members comprises a first joining portion slidable close to or away from the first end or the second end and a second joining portion rotatably connected to the holding member, and each of the sound generating modules comprises at least one venting hole.

6. The headphone device as claimed in claim 5, wherein the first joining portion and the second joining portion are detachably joined through engagement of an engaging rib and an engaging groove extending along a direction perpendicular to the headband.

7. The headphone device as claimed in claim 5, wherein each of the joining portion further comprises a sliding portion connected to the first joining portion, and the headband further comprises a sliding groove for the sliding portion sliding therein.

8. The headphone device as claimed in claim 7, wherein each of the joining members further comprises a rack portion disposed on one side of the sliding portion, the two rack portions of the pair of joining members are opposite to each other, and
wherein the headband further comprises a gear meshing the rack portions, whereby the pair of joining members slide synchronously in opposite directions.

9. The headphone device as claimed in claim 8, wherein each of the joining members further comprises a stop portion disposed at one end of each of the rack portions, and the movement of the joining members is limited by contact of the stop portion and the gear.

10. The headphone device as claimed in claim 1, wherein each of the sound generating modules comprises a charging port and an electrical connection portion, a charging cable is inserted into the charging port, and the electrical connection portions of the pair of the sound generating modules contact, whereby the sound generating modules are parallel connected for electrical charging.

11. The headphone device as claimed in claim 1, wherein the headband further comprises a pad disposed on one side facing the sound generating modules and between the first end and the second end.

12. The headphone device as claimed in claim 1, wherein each of the joining members comprises an abutting spring sheet and a guiding plate, each of the holding members comprises an abutting plate disposed between the abutting spring sheet and the guiding plate, the guiding plate has a planar portion and an arced portion, the abutting spring sheet abuts on the abutting plate to enable the abutting plate to abut on the planar portion when the holding members are at the stretch position, the abutting plate move along the arced portion when the holding members move toward the fold position, and the abutting spring sheet abuts on an edge of the abutting plate to position the holding members at the fold position after the holding member arrives the fold position.

13. The headphone device as claimed in claim 1, wherein each of the sound generating modules further comprises a joining pin, each of the holding members further comprises a joining hole, the sound generating module is detachably joined to the holding portion through insertion of the joining pin into the joining hole.

14. A headphone device, comprising:
an arc-shaped headband having a first end and a second opposite to the first end;
a pair of joining members disposed on the head band, wherein each of the joining members comprises an upper contact portion, and one of the upper contact portions extends towards another one of the joining members; and
a pair of sound generating modules joined to the pair of joining members respectively.

15. The headphone device as claimed in claim 14, further comprising a pair of holding members joined to the pair of joining members respectively, wherein each of the holding members comprises a holding portion for disposing each of the sound generating modules and a first lower extending portion, and one of the first lower extending portions extend towards the other one of the holding members.

16. The headphone device as claimed in claim 15, wherein each of the holding members further comprises a first lower contact portion enclosing an outer surface of the first lower extending portion having a shape of bending rod.

17. The headphone device as claimed in claim 15, wherein each of the holding members further comprises a second lower extension portion disposed at the holding portion and opposite to the first lower extension portion, and the second lower extension portion extends towards the other one of the holding members.

18. The headphone device as claimed in claim 17, wherein the second extension portion comprises a radial wall radially extending from the holding portion and an axial wall perpendicular to the radial wall, and the axial wall is opposite to the first lower extension portion.

19. The headphone device as claimed in claim 17, wherein each of the holding members further comprises a second lower contact portion disposed at an edge of the axial wall.

20. The headphone device as claimed in claim 14, further comprising a pair of holding members, wherein each of the holding members comprises a holding portion in which the sound generating module is disposed, an abutting portion protruding away from the holding member and a first lower contact portion disposed at an end of abutting portion away from the holding portion, and the abutting portions of the holding members abut against each other when the holding members rotate towards the head band.

21. The headphone device as claimed in claim 14, further comprising a pair of holding members, wherein each of the holding members comprises a holding portion for disposing each of the sound generating modules, a lower extension portion extending from the holding portion towards the other one of the holding members and a second contact portion disposed at an edge of the lower extension portion, and the lower extension portion has an arced shape.

22. The headphone device as claimed in claim 14, wherein the headband, the joining members and the sound generating module are integrally formed in one piece.
